(19) United States
(12) Patent Application Publication
(10) Pub. No.: US 2006/0050067 A1
(43) Pub. Date: Mar. 9, 2006

(54) Plasma display apparatus and driving method thereof

(76) Inventors: Jong Woon Kwak, Anyang-si (KR); Tae Hyung Kim, Seoul (KR); Seong Hak Moon, Seoul (KR)

Correspondence Address: MCKENNA LONG & ALDRIDGE LLP;Song K. Jung, 1900 K Street, N.W., Washington, DC, 20006, US

(21) Appl. No.: 11/219,859

(22) Filed: Sep. 7, 2005

(30) Foreign Application Priority Data
Sep. 7, 2004 (KR) 10-2004-0071461
Sep. 7, 2004 (KR) 10-2004-0071462

(51) Int. Cl. G09G 5/00

(52) U.S. Cl. 345/211; 345/21

(57) ABSTRACT

The present invention relates to a plasma display apparatus and a method for driving a plasma display apparatus, and more particularly, to a method for driving a plasma display apparatus including an energy recovery circuit. The plasma display apparatus according to the present invention is characterized in that it includes a path forming unit which serves to supply the first energy to the scan electrode and supply the second energy to the sustain electrode; serves to supply the first sustain voltage to the scan electrode and supply the second sustain voltage to the sustain electrode; serves to supply the first energy to the sustain electrode and supply the second energy to the scan electrode; and also serves to supply the first sustain voltage to the sustain electrode and supply the second sustain voltage to the scan electrode. The plasma display apparatus according to the present invention may useful to reduce a manufacturing cost by using a relatively low rated voltage and therefore inexpensive elements.

This Nonprovisional application claims priority under 35 U.S.C. § 119(a) on Patent Applications Nos. 10-2004-0071461 & 10-2004-0071462 filed in Korea on Sep. 7, 2004, the entire contents of which are hereby incorporated by reference.

### BACKGROUND OF THE INVENTION

1. Field of the Invention

The present invention relates to a plasma display apparatus and a method for driving a plasma display apparatus, and more particularly, to a method for driving a plasma display apparatus including an energy recovery circuit.

2. Description of the Background Art

Generally, there is several kinds of a flat display apparatus such as LCD, FED, organic EL, plasma display apparatus and so on, particularly a plasma display apparatus shows an image by allowing a phosphor to emit the light which is formed inside due to a vacuum ultraviolet rays generated when inert gas present between a front substrate and a rear substrate made of soda-lime glass is discharged by high frequency voltage.

Generally, a plasma display panel displays a image containing characters or graphics by allowing a phosphor to emit the light with ultraviolet ray of 147 nm generated by discharge of He+Xe or Ne+Xe inert gas mixture.

FIG. 1 is a perspective view illustraing the structure of a conventional plasma display panel. As shown in FIG. 1, the plasma display panel includes a scan electrode 12A and a sustain electrode 12B formed on an upper substrate 10, and an address electrode 20 formed on a lower substrate 18.

The scan electrode 12A and the sustain electrode 12B each include a transparent electrode and a bus electrode. The transparent electrode is made of Indium-Tin-Oxide (ITO). The bus electrode is made of a metal to reduce resistance.

An upper dielectric layer 14 and a protection layer 16 is laminated onto the upper substrate 10 on which the scan electrode 12A and the sustain electrode 12B are formed.

A wall charge generated by discharge of the plasma is accumulated on the upper dielectric layer 14. The protection layer 16 prevnts a damage of the upper dielectric layer 14 by sputtering generated by discharge of the plasma, and also enhances emission efficiency of secondary electrons. The protection layer 16 is generally formed of magnesium oxide (MgO).

Meanwhile, a lower dielectric layer 22 and a barrier rib 24 are formed on a lower substrate 18 on which the address electrode 20 is formed. Surfaces of the lower dielectric layer 22 and the barrier rib 24 are coated with a phosphor layer 26.

The address electrode 20 is formed in a dirction that the scan electrode 12A and the sustain electrode 12B are crossed. The seperator 24 is formed with parallel to the address electrode 20, thereby preventing an ultraviolet ray and a visible ray generated by discharging from being leaked to adjascent discharge cells.

The phosphor layer 26 is excited by the ultraviolet ray generated by discharge of the plasma, thereby generating at least one visible ray from red, green or blue. An inert gas mixture such as He+Xe, Ne+Xe and others is injected into a discharge space of a discharge cell provided between the upper/lower substrates 10, 18 and the barrier rib 24.

FIG. 2 shows a recovery circuit of energy of a prior plasma display apparatus, and FIG. 3 shows a waveform view of a sustain pulse according to operation of a conventional energy recovery circuit.

The conventinlal energy recovery circuit is mainly operated according to a four-step operation order.

In the first step, a first switch Q1 for a scan electrode and a fourth switch Q4′ for a sustain electrode contained in a energy recovery circuit 210 for a scan electrode are turned on, and a second to a fourth switches Q2, Q3, Q4 for a scan electrode and a first to a third switches Q1′, Q2′, Q3′ for a sustain electrode are turned off.

Therefore, as shown in FIG. 3, an energy stored in a capacitor Cs1 is supplied to a panel Cp by means of resonance of a coil L1, thereby causing a voltage (hereinafter, referred to as V_{PY}) to be increased in the scan electrode.

Next in the second step, a second switch S2 for a scan electrode is turned on, and a fourth switch Q4′ for a sustain electrode is kept in the turned-on state, and a first switch Q1 for a scan electrode, a third switch Q3 for a scan electrode and a fourth switch Q4 for a scan electrode are turned off. As a result, the V_{PY} is sustained at the sustain voltage Vs.

Subsequently, in the third step, a third switch Q3 for a scan electrode is turned on, and a fourth switch Q4′ for a sustain electrode is kept in the turned-on state, and a first switch Q1 for a scan electrode, a third switch Q3 for a scan electrode and a fourth switch Q4 for a scan electrode are turned off.

Therefore, an energy being stored at capacitor Cp is discharged into the capacitor Cs1 by means of resonance of a coil L1, thereby causing the energy to be recovered and the V_{PY} to be droped.

Finally, in the fourth step, a fourth switch Q4 for a scan electrode is turned on, and a fourth switch Q4′ for a sustain electrode is kept in the turned-on state, and a first switch Q1 for a scan electrode, a second switch Q2 for a scan electrode and a third switch Q3 for a scan electrode are turned off. As a result, the V_{PY} is dropped to a ground level.

The sustain pulse is applied to the scan electrode by means of such a process.

Meanwhile, in the process where the sustain pulse is applied to the scan electrode, the operation order of the first to the fourth switch Q1′˜Q4′ for a sustain electrode is identical to the above-described operation order of the first to the fourth switch Q1˜Q4 for a sustain electrode.

Rated voltage of the separate elements constituting the conventional energy recovery circuit should be higher because such a conventional recovery circuit uses a sustain voltage which is high voltage. Therefore, Expensive elements should be used to construct the conventional energy recovery circuit. Use of the expensive elements has a problem of increasing a manufacturing cost of the plasma display apparatus.

### SUMMARY OF THE INVENTION

Accordingly, an object of the present invention is to solve at least the problems and disadvantages of the background art.

A plasma display apparatus of the present invention includes a plasma display panel including a scan electrode and a sustain electrode; a first energy supply unit for supplying a first energy corresponding to a first voltage by means of resonance and supplying a first sustain voltage, followed by recovering the first energy by means of resonance; a second energy supply unit for supplying a second energy corresponding to a second voltage having an opposite polarity to the first voltage by means of resonance and supplying a second sustain voltage having an opposite polarity to the first sustain voltage, followed by recovering the second energy by means of resonance; and a path forming unit which serves to supply the first energy to the scan electrode and supply the second energy to the sustain electrode; serves to supply the first sustain voltage to the scan electrode and simultaneously supply the second sustain voltage to the sustain electrode; serves to supply the first energy to the sustain electrode and supply the second energy to the scan electrode, and also serves to supply the first sustain voltage to the sustain electrode and simultaneously supply the second sustain voltage to the scan electrode.

A plasma display apparatus of the present invention includes a plasma display panel including a scan electrode and a sustain electrode; a first energy supply unit for supplying a first energy corresponding to a first voltage by means of resonance, and supplying a first sustain voltage, followed by recovering the first energy by means of resonance; a second energy supply unit for supplying a second energy corresponding to a second voltage having an opposite polarity to the first voltage by means of resonance, and supplying a second sustain voltage having an opposite polarity to the first sustain voltage, followed by recovering the second energy by means of resonance; a first voltage sustain unit for applying the first sustain voltage or a ground level of a voltage; a second voltage sustain uint for applying the second sustain voltage or a ground level of a voltage; and a path forming unit which serves to supply the first energy to the scan electrode and supply the second energy to the sustain electrode; serves to supply the first sustain voltage from at least one of the first energy supply unit and the first voltage sustain unit to the scan electrode and simultaneously supply the second sustain voltage from at least one of the second energy supply unit and the second voltage sustain unit to the sustain electrode; serves to supply the first energy to the sustain electrode and supply the second energy to the scan electrode; and also serves to supply the first sustain voltage from at least one of the first energy supply uint and the first voltage sustain unit to the sustain electrode and supply the second sustain voltage from at least one of the second energy supply unit and the second voltage sustain unit to the scan electrode.

A method for driving a plasma display apparatus according to the present invention includes forming a path to supply the first energy to the scan electrode and forming a path to supply the second energy to the sustain electrode; forming a path to supply the first sustain voltage to the scan electrode and forming a path to supply the second sustain voltage to the sustain electrode; forming a path to recover the first energy from the scan electrode and recover the second energy from the sustain electrode; forming a path to supply a ground level of a voltage to the scan electrode and supply a ground level of a voltage to the sustain electrode; forming a path to supply the first energy to the sustain electrode and supply the second energy to the scan electrode; forming a path to supply the first sustain voltage to the sustain electrode and supply the second sustain voltage to the scan electrode; forming a path to recover the first energy from the sustain electrode and recover the second energy from the scan electrode; and forming a path to supply a ground level of a voltage to the sustain electrode and supply a ground level fo a voltage to the scan electrode.

In the present invention, it is possible to reduce a manufacturing cost by using low-priced elements and therefore inexpensive elements.

### BRIEF DESCRIPTION OF THE DRAWINGS

The invention will be described in detail with reference to the following drawings in which like numerals refer to like elements.

FIG. 1 is a perspective view illustrating the structure of a conventional plasma display panel.

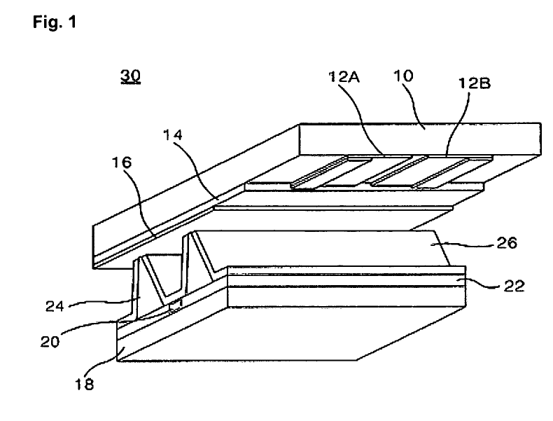

FIG. 2 shows an energy recovery circuit of a conventional plasma display apparatus.

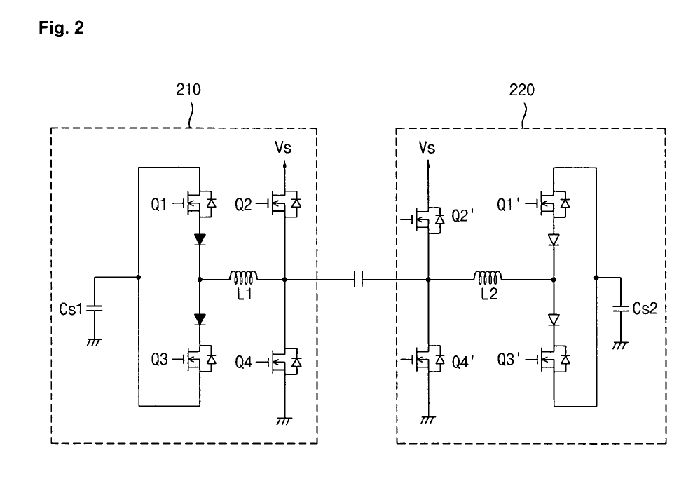

FIG. 3 shows a waveform view of a sustain pulse according to operation of the conventional energy recovery circuit.

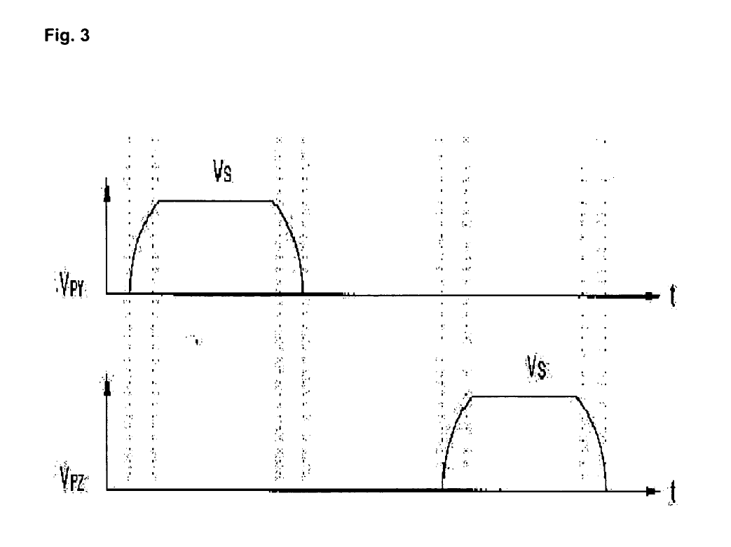

FIG. 4 shows a circuit diagram of a plasma display apparatus according to a first embodiment of the present invention.

FIG. 5 shows a waveform view in accordance with operation of the plasma display apparatus according to the first embodiment of the present invention.

FIG. 6 shows a circuit diagram of the plasma display apparatus according to a second embodiment of the present invention.

FIG. 7 shows a waveform view in accordance with operation of the plasma display apparatus according to the second embodiment of the present invention.

### DETAILED DESCRIPTION OF PREFERRED EMBODIMENTS

Preferred embodiments of the present invention will be described in a more detailed manner with reference to the drawings.

A plate display apparatus according to the present invention includes a display panel, a frame disposed at a rear of the display panel, and at least two thermal conductive sheets formed on a side between the display panel and the frame, wherein the thermal conductive sheets separated apart at a predetermined interval. The plasma display apparatus of the present invention includes a plasma display apparatus including a plasma display panel including a scan electrode and a sustain electrode; a first energy supply unit for supplying a first energy corresponding to a first voltage by means of resonance and supplying a first sustain voltage, followed by recovering the first energy by means of resonance; a second energy supply unit for supplying a second energy corresponding to a second voltage having an opposite polarity to the first voltage by means of resonance and supplying a second sustain voltage having an opposite polarity to the first sustain voltage, followed by recovering the second energy by means of resonance; and a path forming unit which serves to supply the first energy to the scan electrode and supply the second energy to the sustain electrode; serves to supply the first sustain voltage to the scan electrode and simultaneously supply the second sustain voltage to the sustain electrode; serves to supply the first energy to the sustain electrode and supply the second energy to the scan electrode, and also serves to supply the first sustain voltage to the sustain electrode and simultaneously supply the second sustain voltage to the scan electrode.

The present invention is characterized in that the first energy supply unit supplies or recovers energy corresponding to the first voltage as much as 0.5 times of the first sustain voltage.

The present invention is characterized in that the second energy supply unit supplies or recovers energy corresponding to the second voltage as much as 0.5 times of the second sustain voltage.

The present invention is characterized in that the first energy supply unit supplies the first sustain voltage as much as 0.5 times of the sustain voltage, and the second energy supply unit supplies the second sustain voltage as much as 0.5 times of the negative sustain voltage.

The present invention is characterized in that the first energy supply unit includes a) a first supply recovery unit including an energy storing unit for storing energy corresponding to a first voltage; a first switch for forming a path to supply energy corresponding to the first voltage; a second switch for forming a path to recover energy corresponding to the first voltage; and a first inductor for supplying or recovering energy corresponding to the first voltage by means of resonance, and b) a first voltage applying uint including a third switch for applying the first sustain voltage and a fourth switch for recovering energy corresponding to the first voltage, followed by applying a ground level of a voltage.

The present invention is characterized in that the second energy supply unit includes a) a second supply recovery unit including an energy storing unit for storing energy corresponding to the second voltage; the twelfth switch for forming a path to supply energy corresponding to the second voltage; an eleventh switch for forming a path to recover energy corresponding to the second voltage; and a second inductor for supplying or recovering energy corresponding to the second voltage by means of resonance, and b) a second voltage applying unit including a tenth switch for applying the second sustain voltage and a ninth switch for recovering energy corresponding to the second voltage, followed by applying a ground level of a voltage.

The present invention is characterized in that the path forming unit includes a) a fifth switch for supplying or recovering the first energy to the scan electrode and applying the first sustain voltage or the ground level of the voltage to the scan electrode; b) an eighth switch for supplying or recovering the second energy to the sustain electrode and applying the second sustain voltage or the ground level of the voltage to the sustain electrode; c) a seventh switch for supplying or recovering the first energy to the sustain electrode and applying the first sustain voltage or the ground level of the voltage to the sustain electrode; and d) a sixth switch for supplying or recovering the second energy to the scan electrode and applying the second sustain voltage or the level of the voltage to the scan electrode.

The present invention is characterized in that the fifth switch has one end connected with the scan electrode and the other end connected with the first energy supply unit; the eighth switch has one end connected with the sustain electrode and the other end connected with the second energy supply unit; the seventh switch has one end connected with the sustain electrode and the other end connected with the other end of the fifth switch; and the sixth switch has one end connected with the scan electrode and the other end connected with the other end of the eighth switch.

A plasma display apparatus of the present invention includes a plasma display panel including a scan electrode and a sustain electrode; a first energy supply unit for supplying a first energy corresponding to a first voltage by means of resonance, and supplying a first sustain voltage, followed by recovering the first energy by means of resonance; a second energy supply unit for supplying a second energy corresponding to a second voltage having an opposite polarity to the first voltage by means of resonance, and supplying a second sustain voltage having an opposite polarity to the first sustain voltage, followed by recovering the second energy by means of resonance; a first voltage sustain unit for applying the first sustain voltage or a ground level of a voltage; a second voltage sustain uint for applying the second sustain voltage or a ground level of a voltage; and a path forming unit which serves to supply the first energy to the scan electrode and supply the second energy to the sustain electrode; serves to supply the first sustain voltage from at least one of the first energy supply unit and the first voltage sustain unit to the scan electrode and simultaneously supply the second sustain voltage from at least one of the second energy supply unit and the second voltage sustain unit to the sustain electrode; serves to supply the first energy to the sustain electrode and supply the second energy to the scan electrode; and also serves to supply the first sustain voltage from at least one of the first energy supply uint and the first voltage sustain unit to the sustain electrode and supply the second sustain voltage from at least one of the second energy supply unit and the second voltage sustain unit to the scan electrode.

The present invention is characterized in that the first energy supply unit supplies or recovers energy corresponding to the first voltage as much as 0.5 times of the first sustain voltage.

The present invention is characterized in that the second energy supply unit supplies or recovers energy corresponding to the second voltage as much as 0.5 times of the second sustain voltage.

The present invention is characterized in that the first energy supply unit and the first voltage sustain unit supplies the first sustain voltage as much as 0.5 times of the sustain voltage, and the second energy supply unit and the second voltage sustain unit supplies the second sustain voltage as much as 0.5 times of the negative sustain voltage.

The present invention is characterized in that the path forming unit includes a) a fifth switch for supplying or recovering the first energy to the scan electrode and applying the first sustain voltage or a ground level of a voltage to the scan electrode; b) a eighth switch for supplying or recovering the second energy to the sustain electrode and applying the second sustain voltage or a ground level of a voltage to the sustain electrode; c) a seventh switch for supplying or recovering the first energy to the a sustain electrode and applying the first sustain voltage or a ground level of a voltage to the sustain electrode; and d) a sixth switch for supplying or recovering the second energy to the scan electrode and applying the second sustain voltage or a ground level of a voltage to the scan electrode.

The present invention is characterized in that the fifth switch has one end connected with the scan electrode and the other end connected together with the first energy supply unit and the first voltage sustain unit; the eighth switch has one end connected with the sustain electrode and the other end connected together with the second energy supply unit and the second voltage sustain unit; the seventh switch has one end connected with the sustain electrode and the other end connected together with the other end of the fifth switch and the first voltage sustain unit; and the sixth switch has one end connected with the scan electrode and the other end connected together with the other end of the eighth switch and the second voltage sustain unit.

The present invention is characterized in that the first voltage sustain unit includes a sixteenth switch M16 for forming a path to apply the first sustain voltage, and a fifteenth switch M15 for forming a path to apply a ground level of a voltage.

The present invention is characterized in that the second voltage sustain unit includes a thirteenth switch for forming a path to supply the first sustain voltage V1, and a fourteenth switch for forming a path to supply a ground level of a voltage.

A method for driving a plasma display apparatus according to the present invention includes forming a path to supply the first energy to the scan electrode and forming a path to supply the second energy to the sustain electrode; forming a path to supply the first sustain voltage to the scan electrode and forming a path to supply the second sustain voltage to the sustain electrode; forming a path to recover the first energy from the scan electrode and recover the second energy from the sustain electrode; forming a path to supply a ground level of a voltage to the scan electrode and supply a ground level of a voltage to the sustain electrode; forming a path to supply the first energy to the sustain electrode and supply the second energy to the scan electrode; forming a path to supply the first sustain voltage to the sustain electrode and supply the second sustain voltage to the scan electrode; forming a path to recover the first energy from the sustain electrode and recover the second energy from the scan electrode; and forming a path to supply a ground level of a voltage to the sustain electrode and supply a ground level fo a voltage to the scan electrode.

The present invention is characterized in that the first voltage is 0.5 times of the first sustain voltage.

The present invention is characterized in that the voltage is 0.5 times of the second sustain voltage.

The present invention is characterized in that the first sustain voltage is 0.5 times of the positive sustain voltage, and the second sustain voltage is 0.5 times of the negative sustain voltage.

Hereinafter, concrete examples according to the present invention will be explained in reference to the accompanying figures, but it should not be understood to limit the scope of the present invention.

### EXAMPLE 1

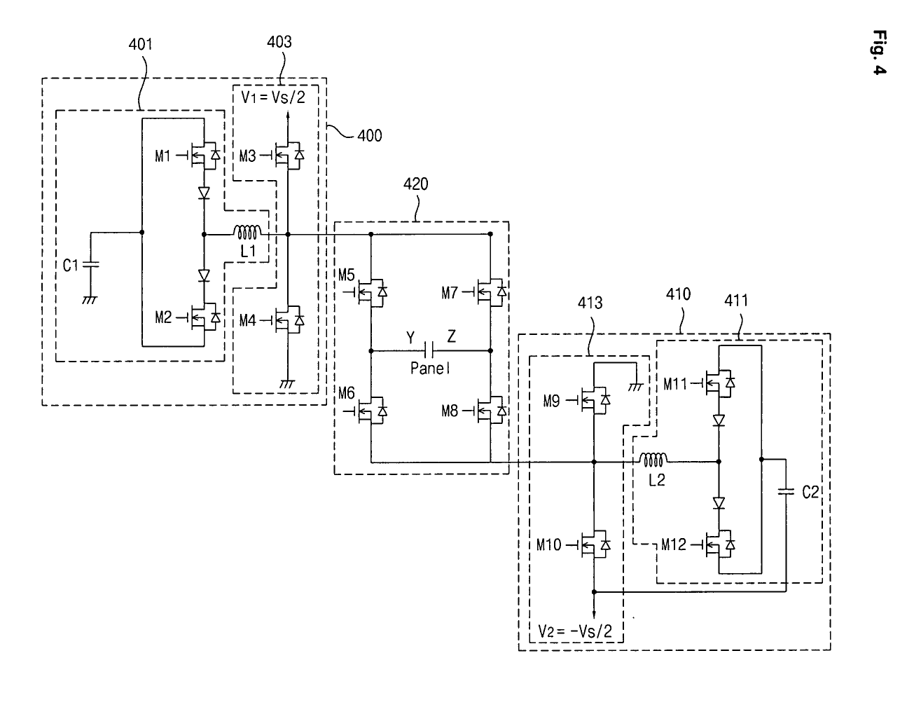

FIG. 4 shows a circuit diagram of a plasma display apparatus according to a first embodiment of the present invention. As shown in FIG. 4, the plasma display apparatus according to the first embodiment of the present invention includes a plasma display panel, a first energy supply unit 400, a second energy supply unit 410 and a path forming unit 420.

The plasma plasma display panel includes a scan electrode Y and a sustain electrode Z.

The first energy supply unit 400 supplies a first energy corresponding to the first voltage by means of resonance, supplies a first sustain voltage V1, and then recovers the first energy by meams of resonance. At this time, the first voltage preferably corresponds to 0.5 times of the first sustain voltage V1, and the first sustain voltage V1 preferably corresponds to 0.5 times of the sustain voltage Vs which generates a sustain discharge.

As described above, the first energy supply unit 400 includes a supply recovery unit 401 and a first voltage applying unit 403. The first supply recovery unit 401 includes a energy storing unit C1 for storing energy corresponding to the first voltage, a first switch M1 for forming a path to supply energy corresponding to the first voltage, a second switch M2 for forming a path to recover energy corresponding to the first voltage, and a first inductor L1 for supplying or recovering energy corresponding to the first voltage by means of resonance. The first voltage applying unit 403 includes a third switch M3 for applying a first sustain voltage V1 and a fourth switch M4 for recovering energy corresponding to the first voltage, followed by applying a ground level of a voltage.

The second energy supply unit 410 supplies a second energy corresponding to a second voltage having an opposite polarity to the first voltage by means of resonance, supplies a second sustain voltage V2 having an opposite polarity to the first sustain voltage V1, and then recovers the second energy by means of resonance. At this time, the second voltage preferably corresponds to 0.5 times of the second sustain voltage V2, and the second sustain voltage V2 preferably corresponds to 0.5 times of the negative sustain voltage −Vs which generates a sustain discharge.

As described above, the second energy supply unit 410 includes a second supply recovery unit 411 and a second voltage applying unit 413. The second supply recovery unit 411 includes a energy storing unit C2 for storing energy corresponding to the second voltage, a mixture switch M12 for forming a path to supply energy corresponding to the second voltage, a eleventh switch M11 for forming a path to recover energy corresponding to the second voltage, and a second inductor L2 for supplying or recovering energy corresponding to the second voltage by means of resonance. The second voltage applying unit 413 includes a tenth switch M10 for applying the second sustain voltage V2 and a ninth switch M9 for recovering energy corresponding to the second voltage, followed by applying a grounf level of a voltage.

The path forming unit 420 serves to supply the first energy to the scan electrode Y and supply the second energy to the sustain electrode Z; serves to supply the first sustain voltage V1 to the scan electrode Y and supply the second sustain voltage V2 to the sustain electrode Z; serves to supply the first energy to the sustain electrode Z and supply the second energy to the scan electrode Y; and also serves to supply the first sustain voltage V1 to the sustain electrode Z and supply the second sustain voltage V2 to the scan electrode Y.

Such a path forming unit 420 includes a fifth switch M5 for supplying or recovering the first energy to/from the scan electrode Y and applying the first sustain voltage V1 or a ground level of a voltage to the scan electrode Y; a eighth switch M8 for supplying or recovering the second energy to/from the sustain electrode Z and applying the second sustain voltage V2 or a ground level of a voltage to the sustain electrode Z; a seventh switch M7 for supplying or recovering the first energy to/from the sustain electrode Z and applying the first sustain voltage V1 or a ground level of a voltage to the sustain electrode Z, and a sixth switch M6 for supplying or recovering the second energy to/from the scan electrode Y and applying the second sustain voltage V2 or a ground level of a voltage to the scan electrode Y.

The above fifth switch M5 has one end connected with the scan electrode Y and the other end connected with the first energy supply unit 400. The eighth switch M8 has one end connected with the sustain electrode Z and the other end connected with the second energy supply membe 410. The seventh switch M7 has one end connected with the sustain electrode Z and the other end connected with the other end of the fifth switch M5. The sixth switch M6 has one end connected with the scan electrode Y and the other end connected with the other end of the eighth switch M8.

Next, operation of the plasma display apparatus according to a first embodiment the present invention will be described in detail in reference to the accompanying figures.

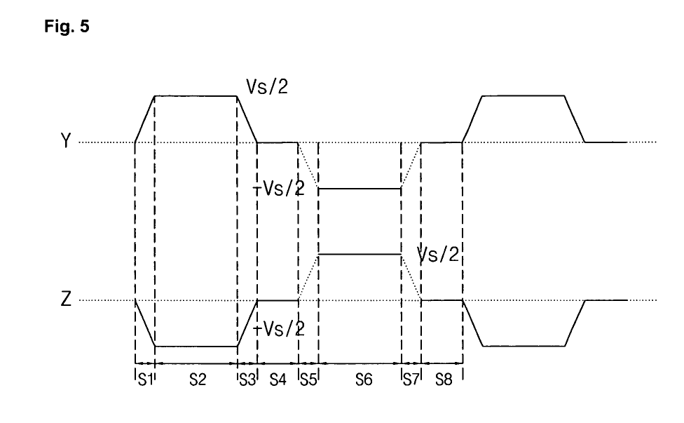

FIG. 5 shows a waveform view in accordance with operation of a plasma display apparatus according to the first embodiment of the present invention.

In the first step S1, the first switch M1 of the first energy supply unit 400 and the fifth switch M5 of the path forming unit 420 are turned on, and the twelfth switch M12 of the second energy supply unit 410 and the eighth switch M8 of the path forming unit 420 are turned off. Therefore, the first energy and the second energy each stored in the first energy storing unit C1 and the second energy storing unit C2 are supplied to a scan electrode Y and a sustain electrode Z by means of resonance with the first inductor L1 and the second inductor L2, respectively. Therefore, a voltage of the scan electrode Y is increased to Vs/2, and a voltage of the sustain electrode Z is reduced to −Vs/2.

In the second step S2, the third switch M3 of the first energy supply unit 400 and the fifth switch M5 of the path forming unit 420 are turned on, and the tenth switch M10 of the second energy supply unit 410 and the eighth switch M8 of the path forming unit 420 are turned off. Therefore, a voltage of the scan electrode Y is sustained at a range of Vs/2, and a voltage of the sustain electrode Z is sustained at a range of −Vs/2.

In the third step S3, the second switch M2 of the first energy supply unit 400 and the fifth switch M5 of the path forming unit 420 are turned on, and the eleventh switch M11 of the second energy supply unit 410 and the eighth switch M8 of the path forming unit 420 are turned off. As a result, the first energy and the second energy are recovered from the scan electrode Y and the sustain electrode Z to the first energy storing unit C1 and the second energy storing unit C2 by means of resonance with the first inductor L1 and the second inductor L2, respectively. Therefore, voltages of the scan electrode Y and the sustain electrode Z are dropped to a ground level.

At the fourth step S4, the fourth switch M4 of the first energy supply unit 400 and the fifth switch M5 of a path forming unit 420 are turn on, and the ninth switch M9 of the second energy supply unit 410 and the eighth switch M8 of the path forming unit 420 are turn on. Therefore, a voltage of a scan electrode Y and a sustain electrode Z is sustained to ground level.

In the fifth step S5, the first switch M1 of the first energy supply unit 400 and the seventh switch M7 of the path forming unit 420 are turned on, and the twelfth switch M12 of the second energy supply unit 410 and the sixth switch M6 of the path forming unit 420 are turned off. Therefore, the first energy and the second energy each stored in the first energy storing unit C1 and the second energy storing unit C2 are supplied to the sustain electrode Z and the scan electrode Y by means of resonance with the first inductor L1 and the second inductor L2, respectively. Therefore, a voltage of the scan electrode Y is dropped to −Vs/2, and a voltage of the sustain electrode Z is increased to Vs/2.

In the sixth step S6, the third switch M3 of the first energy supply unit 400 and the seventh switch M7 of the path forming unit 420 are turned on, and the tenth switch M10 of the second energy supply unit 410 and the eighth switch M8 of the path forming unit 420 are turned on. Therefore, a voltage of the scan electrode Y is sustained at a range of −Vs/2, and a voltage of the sustain electrode Z is sustained at a range of Vs/2.

In the seventh step S7, the second switch M2 of the first energy supply unit 400 and the seventh switch M7 of the path forming unit 420 are turned on, and the eleventh switch M11 of the second energy supply unit 410 and the sixth switch M6 of the path forming unit 420 are turned on. As a result, the first energy and the second energy are recovered from the sustain electrode Z and the scan electrode Y to the first energy storing unit C1 and the second energy storing unit C2 by means of resonance with the first inductor L1 and the second inductor L2, respectively. Therefore, voltages of the scan electrode Y and the sustain electrode Z are dropped to a ground level.

In the eighth step S8, the fourth switch M4 of the first energy supply unit 400 and the seventh switch M7 of the path forming unit 420 are turned on, and the ninth switch M9 of the second energy supply unit 410 and the sixth switch M6 of the path forming unit 420 are turned on. Therefore, voltages of the scan electrode Y and the sustain electrode Z are sustained at a ground level.

As described above, althought, high voltage such as the sustain voltage Vs has been used in the conventional plasma display apparatuses, a voltage of Vs/2 is used in the plasma display apparatus of the present invention. Therefore, it is possible to reduce a manufacturing cost by using relatively low-priced elements.

### EXAMPLE 2

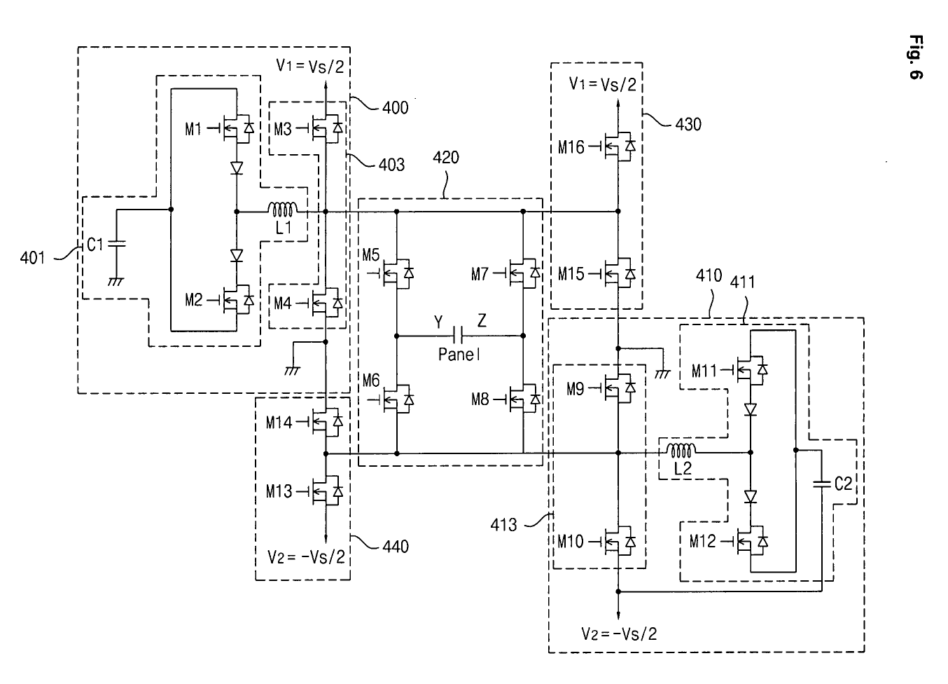

FIG. 6 shows a circuit diagram of a plasma display apparatus according to a second embodiment of the present invention. As shown in FIG. 6, the plasma display apparatus according to the second embodiment of the present invention includes a plasma display panel, a first energy supply unit 400, a second energy supply unit 410, a first voltage sustain unit 430, a second voltage sustain unit 440 and a path forming unit 420.

The plasma plasma display panel includes a scan electrode Y and a sustain electrode Z.

The first energy supply unit 400 supplies a first energy corresponding to the first voltage by means of resonance and supplies a first sustain voltage V1, and then recovers the first energy by means of resonance. At this time, the first voltage preferably corresponds to 0.5 times of the first sustain voltage V1, and the first sustain voltage V1 preferably corresponds to 0.5 times of a sustain voltage Vs which generates a sustain discharge.

Such a first energy supply unit 400 includes a first supply recovery unit 401 and a first voltage applying unit 403. The first supply recovery unit 401 includes an energy storing unit C1 for storing energy corresponding to the first voltage, a first switch M1 for forming a path to supply energy corresponding to the first voltage, a second switch M2 for forming a path to recover energy corresponding to the first voltage, and a first inductor L1 for supplying or recovering energy corresponding to the first voltage by means of resonance. The first voltage applying unit 403 includes a third switch M3 for applying the first sustain voltage V1 and a fourth switch M4 for recovering energy corresponding to the first voltage, followed by applying a ground level of a voltage.

The second energy supply unit 410 supplies a second energy corresponding to the second voltage having an opposite polarity to the first voltage by means of resonance, supplies the second sustain voltage V2 having an opposite polarity to the first sustain voltage V1, and then recovers the second energy by means of resonance. At this time, the second voltage preferably corresponds to 0.5 times of the second sustain voltage V2, and the second sustain voltage V2 preferably corresponds to 0.5 times of the negative sustain voltage −Vs which generates a sustain discharge.

As described above, the second energy supply unit 400 includes a second supply recovery unit 401 and a second voltage applying unit 403. The second supply recovery unit 401 includes an energy storing unit C2 for storing energy corresponding to the second voltage, a twelfth switch M12 for forming a path to supply energy corresponding to the second voltage, a eleventh switch M11 for forming a path to recover energy corresponding to the second voltage, and a second inductor L2 for supplying or recovering energy corresponding to the second voltage by means of resonance. The second voltage applying unit 413 includes a tenth switch M10 for applying the second sustain voltage V2 and a ninth switch M9 for recovering energy corresponding to the second voltage, followed by applying a ground level of a voltage.

The first voltage sustain unit 430 applies the first sustain voltage V1 or a ground level of a voltage. The first voltage sustain unit 430 includes a fifteenth switch M15 and a sixteenth switch M16. The sixteenth switch M16 forms a path to apply the first sustain voltage V1, and the fifteenth switch M15 forms a path to apply a ground level of voltage. The fifteenth switch M15 and the sixteenth switch M16 are connected in series to each other.

The second voltage sustain unit 440 applies the second sustain voltage V2 or a ground level of a voltage. The second voltage sustain unit 440 includes a thirteenth switch M13 and a fourteenth switch M14. The thirteenth switch M13 forms a path to apply the first sustain voltage V1, and the fourteenth switch M14 forms a path to apply a ground level of a voltage. The thirteenth switch M13 and the fourteenth switch M14 are connected in series to each other.

The path forming unit 420 serves to supply the first energy to the scan electrode Y and supply the second energy the sustain electrode Z; serves to supply the first sustain voltage V1 from at least one of the first voltage applying unit 403 of the first energy supply unit 400 and the first voltage sustain unit 430 to the scan electrode Y and supply the second sustain voltage V2 from at least one of the second voltage applying unit 413 of the second energy supply unit 410 and the second voltage sustain unit 440 to the sustain electrode Z; serves to supply the first energy to the sustain electrode Z and supply the second energy to the scan electrode Y; and also serves to supply the first sustain voltage V1 from at least one of the first supply recovery unit 401 of the first energy supply unit 400 and the first voltage sustain unit 430 to the sustain electrode Z and supply the second sustain voltage V2 from at least one of the second voltage applying unit 413 of the second energy supply unit 410 and the second voltage sustain unit 440 to the scan electrode Y.

The above path forming unit 420 includes a fifth switch M5 for supplying or recovering the first energy to/from the scan electrode Y and applying the first sustain voltage V1 or a ground level of a voltage to the scan electrode Y; a eighth switch M8 for supplying or recovering the second energy to/from the sustain electrode Z and applying the second sustain voltage V2 or a ground level of a voltage to the sustain electrode Z; a seventh switch M7 for supplying or recovering the first energy to/from the sustain electrode Z and applying the first sustain voltage V1 or a ground level of a voltage to the sustain electrode Z; and a sixth switch M6 for supplying or recovering the second energy to/from the scan electrode Y and applying the second sustain voltage V2 or a ground level of a voltage to the scan electrode Y.

The fifth switch M5 has one end connected with the scan electrode Y and the other end connected with the first energy supply unit 400. The eighth switch M8 has one end connected with the sustain electrode Z and the other end connected with the second energy supply unit 410. The seventh switch M7 has one end connected with the sustain electrode Z and the other end connected with the other end of the fifth switch M5. The sixth switch M6 has one end connected with the scan electrode Y and the other end connected with the other end of the eighth switch M8.

Next, operation of the plasma display apparatus according to a second embodiment the present invention will be described in detail in reference to the accompanying figures.

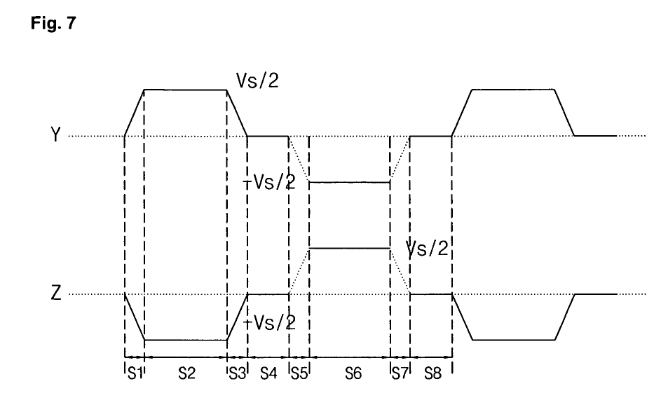

FIG. 7 shows a waveform view in accordance with operation of the plasma display apparatus according to the second embodiment of the present invention.

In the first step S1, the first switch M1 of the first energy supply unit 400 and the fifth switch M5 of the path forming unit 420 are turned on, and the twelfth switch M12 of the second energy supply unit 410 and the eighth switch M8 of the path forming unit 420 are turned on. Therefore, the first energy and the second energy each stored in the first energy storing unit C1 and the second energy storing unit C2 are supplied to the scan electrode Y and the sustain electrode Z by means of resonance with the first inductor L1 and the second inductor L2, respectively. Therefore, a voltage of the scan electrode Y is increased to Vs/2, and a voltage of the sustain electrode Z is dropped to −Vs/2.

In the second step S2, at least one of the third switch M3 of the first energy supply unit 400 and the sixteenth switch M16 of the first voltage sustain unit 430, and the fifth switch M5 of the path forming unit 420 are turned on, and at least one of the tenth switch M10 of the second energy supply unit 410 and the thirteenth switch M13 of the second voltage sustain unit, and the eighth switch M8 of the path forming unit 420 are turned on. Therefore, a voltage of the scan electrode Y is sustained at a range of Vs/2, and a voltage of the sustain electrode Z is sustained at a range of −Vs/2.

In the third step S3, the second switch M2 of the first energy supply unit 400 and the fifth switch M5 of the path forming unit 420 are turned on, and the eleventh switch M11 of the second energy supply unit 410 and the eighth switch M8 of the path forming unit 420 are turned on. As a result, the first energy and the second energy are recovered from the scan electrode Y and the sustain electrode Z to the first energy storing unit C1 and the second energy storing unit C2 by means of resonance with the first inductor L1 the second inductor L2, respectively. Therefore, voltages of the scan electrode Y and the sustain electrode Z are dropped to a ground level.

In the fourth step S4, at least one of the fourth switch M4 of the first energy supply unit 400 and the fifteenth switch M15 of the first voltage sustain unit, and the fifth switch M5 of the path forming unit 420 are turned on, and at least one of the ninth switch M9 of the second energy supply unit 410 and the fourteenth switch M14 of the second voltage sustain unit 440, and the eighth switch M8 of the path forming unit 420 are turned on. Therefore, voltages of the scan electrode Y and the sustain electrode Z are sustained at a ground level.

In the fifth step S5, the first switch M1 of the first energy supply unit 400 and the seventh switch M7 of the path forming unit 420 are turned on, and the twelfth switch M12 of the second energy supply unit 410 and the sixth switch M6 of the path forming unit 420 are turned on. Therefore, the first energy and the second energy each stored in the first energy storing unit C1 and the second energy storing unit C2 are supplied to the sustain electrode Z and the scan electrode Y by means of resonance with the first inductor L1 and the second inductor L2, respectively. Therefore, a voltage of the scan electrode Y is dropped to −Vs/2, and a voltage of the sustain electrode Z is increased to Vs/2.

In the sixth step S6, at least one of the third switch M3 of the first energy supply unit 400 and the sixteenth switch M16 of the first voltage sustain unit 430, and the seventh switch M7 of the path forming unit 420 are turned on, and at least one of the tenth switch M10 of the second energy supply unit 410 and the thirteenth switch M13 of the second voltage sustain unit 440, and the eighth switch M8 of the path forming unit 420 are turned on. Therefore, a voltage of the scan electrode Y is sustained at a range of −Vs/2, and a voltage of the sustain electrode Z is sustained at a range of Vs/2.

In the seventh step S7, the second switch M2 of the first energy supply unit 400 and the seventh switch M7 of the path forming unit 420 are turned on, and the eleventh switch M11 of the second energy supply unit 410 and the sixth switch M6 of the path forming unit 420 are turned on. As a result, the first energy and the second energy are recovered from the sustain electrode Z and the scan electrode Y to the first energy storing unit C1 and the second energy storing unit C2 by means of resonance with the first inductor L1 and the second inductor L2, respectively. Therefore, a voltage of a scan electrode Y and a sustain electrode Z drop to ground level.

In the eighth step S8, at least one of the fourth switch M4 of the first energy supply unit 400 and the fifteenth switch M15 of the first voltage sustain unit 430, and the seventh switch M7 of the path forming unit 420 are turned on, and at least one of the ninth switch M9 of the second energy supply unit 410 and the fourteenth switch M14 of the second voltage sustain unit 440, and the sixth switch M6 of the path forming unit 420 are turned on. Therefore, voltages of the scan electrode Y and the sustain electrode Z are sustained at a ground level.

As described above, the second embodiment is different from the first embodiment in that it further includes the first voltage sustain unit 430 and the second voltage sustain unit 440 so that it can conduct more reliable voltage sustain operation than when specific voltages are sustained in the scan electrode Y or the sustain electrode Z.

As described above, althought, high voltage such as the sustain voltage Vs has been used in the conventional plasma display apparatuses, voltage of Vs/2 is used in the plasma display apparatus of the present invention. Therefore, it is possible to reduce a manufacturing cost by using relatively low-priced elements.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode and a sustain electrode;
a first energy supply unit for supplying a first energy corresponding to a first voltage by means of resonance and supplying a first sustain voltage, followed by recovering the first energy by means of resonance;
a second energy supply unit for supplying a second energy corresponding to a second voltage having an opposite polarity to the first voltage by means of resonance and supplying a second sustain voltage having an opposite polarity to the first sustain voltage, followed by recovering the second energy by means of resonance; and
a path forming unit which serves to supply the first energy to the scan electrode and supply the second energy to the sustain electrode; serves to supply the first sustain voltage to the scan electrode and simultaneously supply the second sustain voltage to the sustain electrode; serves to supply the first energy to the sustain electrode and supply the second energy to the scan electrode, and also serves to supply the first sustain voltage to the sustain electrode and simultaneously supply the second sustain voltage to the scan electrode.

2. The plasma display apparatus according to the claim 1, whrerin the first energy supply unit supplies or recovers energy corresponding to the first voltage as much as 0.5 times of the first sustain voltage.

3. The plasma display apparatus according to the claim 1, whrerin the second energy supply unit supplies or recovers energy corresponding to the second voltage as much as 0.5 times of the second sustain voltage.

4. The plasma display apparatus according to the claim 1, whrerin the first energy supply unit supplies the first sustain voltage as much as 0.5 times of the sustain voltage, and the second energy supply uint supplies the second sustain voltage as mauch as 0.5 times of the negative sustain voltage.

5. The plasma display apparatus according to the claim 1, whrerin the first energy supply unit comprises:
a) a first supply recovery unit comprising an energy storing unit for storing energy corresponding to a first voltage; a first switch for forming a path to supply energy corresponding to the first voltage; a second switch for forming a path to recover energy corresponding to the first voltage; and a first inductor for supplying or recovering energy corresponding to the first voltage by means of resonance, and
b) a first voltage applying uint comprising a third switch for applying the first sustain voltage and a fourth switch for recovering energy corresponding to the first voltage, followed by applying a ground level of a voltage.

6. The plasma display apparatus according to the claim 1, whrerin the second energy supply unit comprises:
a) a second supply recovery unit comprising an energy storing unit for storing energy corresponding to the second voltage; the twelfth switch for forming a path to supply energy corresponding to the second voltage; an eleventh switch for forming a path to recover energy corresponding to the second voltage; and a second inductor for supplying or recovering energy corresponding to the second voltage by means of resonance, and
b) a second voltage applying unit comprising a tenth switch for applying the second sustain voltage and a ninth switch for recovering energy corresponding to the second voltage, followed by applying a ground level of a voltage.

7. The plasma display apparatus according to the claim 1, whrerin the path forming uint comprises:
a) a fifth switch for supplying or recovering the first energy to the scan electrode and applying the first sustain voltage or the ground level of the voltage to the scan electrode;
b) an eighth switch for supplying or recovering the second energy to the sustain electrode and applying the second sustain voltage or the ground level of the voltage to the sustain electrode;
c) a seventh switch for supplying or recovering the first energy to the sustain electrode and applying the first sustain voltage or the ground level of the voltage to the sustain electrode; and
d) a sixth switch for supplying or recovering the second energy to the scan electrode and applying the second sustain voltage or the level of the voltage to the scan electrode.

8. The plasma display apparatus according to the claim 7, whrerin the fifth switch has one end connected with the scan electrode and the other end connected with the first energy supply unit; the eighth switch has one end connected with the sustain electrode and the other end connected with the second energy supply unit; the seventh switch has one end connected with the sustain electrode and the other end connected with the other end of the fifth switch; and the sixth switch has one end connected with the scan electrode and the other end connected with the other end of the eighth switch.

9. A plasma display apparatus comprises:
a plasma display panel comprising a scan electrode and a sustain electrode;
a first energy supply unit for supplying a first energy corresponding to a first voltage by means of resonance, and supplying a first sustain voltage, followed by recovering the first energy by means of resonance;
a second energy supply unit for supplying a second energy corresponding to a second voltage having an opposite polarity to the first voltage by means of resonance, and supplying a second sustain voltage having an opposite polarity to the first sustain voltage, followed by recovering the second energy by means of resonance;
a first voltage sustain unit for applying the first sustain voltage or a ground level of a voltage;
a second voltage sustain uint for applying the second sustain voltage or a ground level of a voltage; and
a path forming unit which serves to supply the first energy to the scan electrode and supply the second energy to the sustain electrode; serves to supply the first sustain voltage from at least one of the first energy supply unit and the first voltage sustain unit to the scan electrode and simultaneously supply the second sustain voltage from at least one of the second energy supply unit and the second voltage sustain unit to the sustain electrode; serves to supply the first energy to the sustain electrode and supply the second energy to the scan electrode; and also serves to supply the first sustain voltage from at least one of the first energy supply uint and the first voltage sustain unit to the sustain electrode and supply the second sustain voltage from at least one of the second energy supply unit and the second voltage sustain unit to the scan electrode.

10. The plasma display apparatus according to the claim 9, whrerin the first energy supply unit supplies or recovers energy corresponding to the first voltage as much as 0.5 times of the first sustain voltage.

11. The plasma display apparatus according to the claim 9, whrerin the second energy supply unit supplies or recovers energy corresponding to the second voltage as much as 0.5 times of the second sustain voltage.

12. The plasma display apparatus according to the claim 9, whrerin the first energy supply unit and the first voltage sustain unit supplies the first sustain voltage as much as 0.5 times of the sustain voltage, and the second energy supply unit and the second voltage sustain unit supplies the second sustain voltage as much as 0.5 times of a negative sustain voltage.

13. The plasma display apparatus according to the claim 9, whrerin the path forming unit comprises:
a) a fifth switch for supplying or recovering the first energy to the scan electrode and applying the first sustain voltage or a ground level of a voltage to the scan electrode;
b) a eighth switch for supplying or recovering the second energy to the sustain electrode and applying the second sustain voltage or a ground level of a voltage to the sustain electrode;
c) a seventh switch for supplying or recovering the first energy to the a sustain electrode and applying the first sustain voltage or a ground level of a voltage to the sustain electrode; and
d) a sixth switch for supplying or recovering the second energy to the scan electrode and applying the second sustain voltage or a ground level of a voltage to the scan electrode.

14. The plasma display apparatus according to the claim 13, whrerin the fifth switch has one end connected with the scan electrode and the other end connected together with the first energy supply unit and the first voltage sustain unit; the eighth switch has one end connected with the sustain electrode and the other end connected together with the second energy supply unit and the second voltage sustain unit; the seventh switch has one end connected with the sustain electrode and the other end connected together with the other end of the fifth switch and the first voltage sustain unit; and the sixth switch has one end connected with the scan electrode and the other end connected together with the other end of the eighth switch and the second voltage sustain unit.

15. The plasma display apparatus according to the claim 9, whrerin the first voltage sustain unit comprises a sixteenth switch M16 for forming a path to apply the first sustain voltage, and a fifteenth switch M15 for forming a path to apply a ground level of a voltage.

16. The plasma display apparatus according to the claim 9, whrerin the second voltage sustain unit comprises a thirteenth switch for forming a path to apply the first sustain voltage V1, and a fourteenth switch for forming a path to apply a ground level of a voltage.

17. A method for driving a plasma display apparatus comprising a scan electrode and a sustain electrode, the method comprising:
forming a path to supply the first energy to the scan electrode and forming a path to supply the second energy to the sustain electrode;
forming a path to supply the first sustain voltage to the scan electrode and forming a path to supply the second sustain voltage to the sustain electrode;
forming a path to recover the first energy from the scan electrode and recover the second energy from the sustain electrode;
forming a path to supply a ground level of a voltage to the scan electrode and supply a ground level of a voltage to the sustain electrode;
forming a path to supply the first energy to the sustain electrode and supply the second energy to the scan electrode;
forming a path to supply the first sustain voltage to the sustain electrode and supply the second sustain voltage to the scan electrode;
forming a path to recover the first energy from the sustain electrode and recover the second energy from the scan electrode; and
forming a path to supply a ground level of a voltage to the sustain electrode and supply a ground level fo a voltage to the scan electrode.

18. The method for driving the plasma display apparatus according to the claim 17, whrerin the first voltage is 0.5 times of the first sustain voltage.

19. The method for driving the plasma display apparatus according to the claim 17, whrerin the second voltage is 0.5 times of the second sustain voltage.

20. The method for driving the plasma display apparatus according to the claim 17, whrerin the first sustain voltage is 0.5 times of a positive sustain voltage, and the second sustain voltage is 0.5 times of a negative sustain voltage.
